(19) United States
(12) Patent Application Publication
(10) Pub. No.: US 2026/0091665 A1
(43) Pub. Date: Apr. 2, 2026

(54) SYSTEMS AND METHODS FOR RELEASING GASES FROM A SEALED HOUSING COMPRISING A BATTERY MODULE

(71) Applicant: GM GLOBAL TECHNOLOGY OPERATIONS LLC, Detroit, MI (US)

(72) Inventors: Ryan Patrick Hickey, Austin, TX (US); Julian Roy Sherborne, South Lyon, MI (US); Jaideep Singh, West Bloomfield, MI (US)

(73) Assignee: GM GLOBAL TECHNOLOGY OPERATIONS LLC, Detroit, MI (US)

(21) Appl. No.: 18/903,838

(22) Filed: Oct. 1, 2024

(51) Int. Cl. B60K 13/04; B60R 16/04; H01M 50/342; H01M 50/358

(52) U.S. Cl. CPC B60K 13/04; B60R 16/04; H01M 50/3425; H01M 50/358; H01M 2220/20

(57) ABSTRACT

Systems and methods are provided for releasing gases from a sealed housing, such as a housing of a rechargeable energy storage system, comprising a battery module to an exhaust system. The systems include a conduit configured to receive exhaust gases from a combustion engine of the vehicle and direct the exhaust gases to an outlet for release into an ambient environment exterior to the vehicle, a sealed housing with an internal compartment therein and at least one battery module within the internal compartment, and a device fluidically coupling the internal compartment of the sealed housing and the conduit, wherein the device is configured to selectively allow gases within the internal compartment to enter the conduit and thereby be directed to the outlet thereof and released to the ambient environment.

### INTRODUCTION

The technical field generally relates to electric and hybrid electric vehicles, and more particularly relates to thermal runaway prevention and mitigation for rechargeable energy storage systems (RESSs).

Electric and hybrid electric vehicles include rechargeable energy storage systems (RESSs). In a hybrid vehicle, the RESS is charged through operation of an engine operating on fossil fuels or through regenerative braking. Electric vehicles rely on an external energy supply to recharge the RESS. A RESS typically includes multiple sealed cells or battery modules that store electrical energy. In operation or during charging, one or more of the battery modules may overheat. When a battery module overheats, undesirable gases may be produced, leading to increases in pressure and temperature. In extreme cases, the increase in temperature of a battery module may affect adjacent battery modules leading to further reactions that produce even more heat and potentially ignition of the undesirable gases, creating a feedback loop that can result in catastrophic failure, a process referred to as thermal runaway.

As such, electric and hybrid electric vehicles may include various systems for providing thermal management of an RESS such as cooling systems intended to maintain optimal operating temperatures, battery management systems configured to monitor the state of the battery modules to reduce the likelihood of overcharging and overheating, and physical structures and materials intended to mitigate risks, such as vents for releasing the undesirable gases from the RESS.

Despite the benefits of the above-noted systems, there is an ongoing desire for systems and methods that are capable of reducing the likelihood of thermal runaway and/or mitigating the damage thereof. Furthermore, other desirable features and characteristics of the present disclosure will become apparent from the subsequent detailed description and the appended claims, taken in conjunction with the accompanying drawings and the foregoing introduction.

### SUMMARY

A system is provided for a vehicle. In one example, the system includes a conduit configured to receive exhaust gases from a combustion engine of the vehicle and direct the exhaust gases to an outlet for release into an ambient environment exterior to the vehicle, a sealed housing with an internal compartment therein and at least one battery module within the internal compartment, and a device fluidically coupling the internal compartment of the sealed housing and the conduit, wherein the device is configured to selectively allow gases within the internal compartment to enter the conduit and thereby be directed to the outlet thereof and released to the ambient environment.

In some examples, the device of the system may include a one-way, passive valve configured to allow passage of the gases from the internal compartment to the conduit in response to a gas pressure within the internal compartment exceeding a predetermined threshold.

In some examples, the device of the system may include an electronically controlled valve and a controller having one or more processors, wherein the controller is configured to, by the one or more processors, open the electronically controlled valve to allow passage of the gases from the internal compartment to the conduit in response to a gas pressure within the internal compartment exceeding at least a first threshold.

In some examples, the device of the system may include a burst disc configured to rupture and thereby allow passage of the gases from the internal compartment to the conduit in response to a gas pressure within the internal compartment exceeding a predetermined threshold.

In some examples, the device of the system may fluidically couple to the conduit at a position that is sufficiently upstream of the outlet to dilute the gases directed therethrough and reduce a likelihood of auto-ignition upon being released to the ambient environment.

In some examples, the device of the system may be configured to function as an emergency water access port wherein water can be directed through the conduit, through the device, and into the internal compartment.

In some examples, the device of the system may be configured to selectively allow passage of the gases from the internal compartment to the conduit to equalize gas pressure between the internal compartment and the conduit.

In some examples, the conduit of the system is configured to direct the gases from the device to a tailpipe at a rear of the vehicle for release into the ambient environment.

In some examples, the device of the system may be configured to allow passage of the gases from the internal compartment to the conduit in response to a gas pressure within the internal compartment exceeding a predetermined threshold corresponding to a potential or active thermal runaway event.

A method is provided for a vehicle. In one example, the method includes directing an exhaust gas produced by a combustion engine of the vehicle through a conduit to an outlet for release into an ambient environment exterior to the vehicle, and selectively allowing gases within an internal compartment of a sealed housing to enter the conduit and thereby be directed to the outlet thereof and released to the ambient environment. The sealed housing may include at least one battery module within the internal compartment.

In some examples, the internal compartment of the method may be fluidically coupled to the conduit via a passive, one-way valve, wherein selectively allowing the gases within the internal compartment of the sealed housing to enter the conduit includes configuring the one-way valve to open in response to a gas pressure within the internal compartment exceeding a predetermined threshold.

In some examples, the internal compartment of the method may be fluidically coupled to the conduit via an electronically controlled valve, wherein selectively allowing the gases within the internal compartment of the sealed housing to enter the conduit includes opening, with a controller having one or more processors, the electronically controlled valve in response to a gas pressure within the internal compartment exceeding at least a first threshold.

In some examples, the internal compartment of the method may be fluidically coupled to the conduit via a burst disc, wherein selectively allowing the gases within the internal compartment of the sealed housing to enter the conduit includes configuring the burst disc to rupture in response to a gas pressure within the internal compartment exceeding a predetermined threshold.

In some examples, the method may include diluting the gases with the exhaust gas within the conduit prior to a mixture thereof being released to the ambient environment.

In some examples, the method may include supplying water into the outlet, through the conduit, and into the internal compartment of the sealed housing via an emergency water access port.

In some examples, selectively allowing the gases within the internal compartment of the sealed housing to enter the conduit may be performed to equalize gas pressure between the internal compartment and the conduit.

In some examples, allowing passage of the gases from the internal compartment to the conduit may be performed in response to a gas pressure within the internal compartment exceeding a predetermined threshold corresponding to a potential or active thermal runaway event.

A vehicle is provided that, in one example, includes a combustion engine, an exhaust system having a conduit configured to direct exhaust gases from the combustion engine to an outlet for release into an ambient environment exterior to the vehicle, a rechargeable energy storage system (RESS) having a housing with an internal compartment therein and at least one battery module within the internal compartment, and a device fluidically connecting the internal compartment of the RESS and the conduit of the exhaust system. The device may be configured to selectively allow gases within the internal compartment of the RESS to enter the conduit and thereby be directed to the outlet for release into to the ambient environment in response to a gas pressure within the internal compartment exceeding a predetermined threshold corresponding to a potential or active thermal runaway event.

In some examples, the device of the vehicle may be configured to function as an emergency water access port wherein water can be directed into the outlet, through the conduit, through the device, and into the internal compartment.

In some examples, the device of the vehicle may include a passive, one-way valve, an electronically controller valve, or a burst disc configured to allow passage of the gases from the internal compartment to the conduit in response to the gas pressure within the internal compartment exceeding the predetermined threshold.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle having a system for prevention and/or mitigation of thermal runaway events in accordance with an example;

FIG. 2 is a first example of the system of FIG. 1 including a device for fluidically coupling a rechargeable energy storage system with an exhaust system in accordance with an example;

FIG. 3 is a second example of the system of FIG. 1 including a device for fluidically coupling a rechargeable energy storage system with an exhaust system in accordance with an example;

FIG. 4 is a third example of the system of FIG. 1 including a device for fluidically coupling a rechargeable energy storage system with an exhaust system in accordance with an example; and

FIG. 5 is a flowchart illustrating an exemplary method for prevention and/or mitigation of thermal runaway events in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

Examples of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that examples of the present disclosure may be practiced in conjunction with any number of systems, and that the systems described herein is merely examples of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example of the present disclosure.

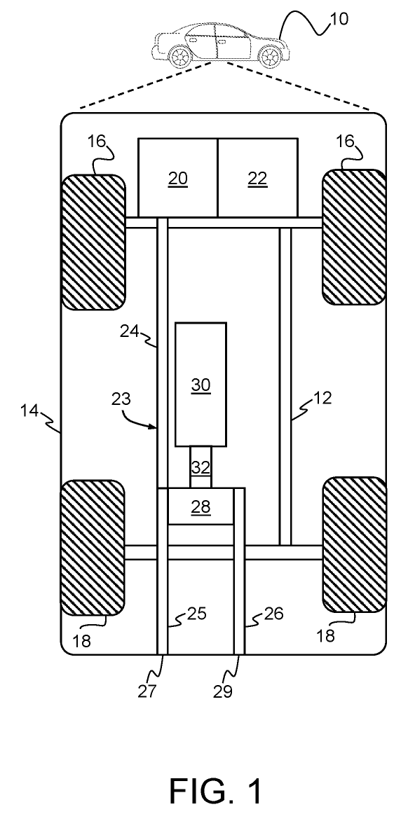

FIG. 1 illustrates a vehicle 10, according to an example. In certain examples, the vehicle 10 comprises an automobile. The vehicle 10 includes a system that provides for fluidic communication between a rechargeable energy storage systems (RESS) 30 and an exhaust system 23 for thermal runaway prevention and mitigation. Although the examples herein are discussed in reference to the RESS 30, it should be understood that the teachings disclosed herein are applicable to other apparatuses having sealed housings, such as housings storing vehicle battery modules that are not associated with an RESS.

In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20, a transmission system 22, an exhaust system 23, and a rechargeable energy storage system (RESS) 30. The propulsion system 20 includes an internal combustion engine (e.g., a gasoline or diesel fueled combustion engine). In some examples, the propulsion system 20 is a hybrid system that includes the internal combustion engine and an electric motor (e.g., a 3-phase AC motor). The transmission system 22 is configured to transmit power from the propulsion system 20 to the wheels 16, 18 according to selectable speed ratios. According to various examples, the transmission system 22 may include a step-ratio automatic transmission, a continuously-variable transmission, or other appropriate transmission.

The exhaust system 23 may include various components for conveying exhaust gases from combustion chambers of the internal combustion engine to a tailpipe for discharge to an ambient environment exterior to the vehicle 10 (i.e., atmosphere). For example, the exhaust system 23 may include a first conduit 24 (e.g., pipe section) for receiving the exhaust gases from the engine and directing the exhaust gases to a resonator 28 for modifying sounds produced by the engine, and second and third conduits 25, 26 for directing the exhaust gases from the resonator 28 to a first and second outlets 27, 29 (e.g., first and second tailpipes). In some examples, the exhaust system 23 may have fewer or more conduits and/or may include other components and systems not shown in FIG. 1. For example, the exhaust system 23 may include one or more conduits that direct the exhaust gases through aftertreatment devices of an emissions control system (not shown). As another example, the exhaust system 23 may include one or more conduits that direct the exhaust gases through one or more mufflers prior to release from the first and second outlets 27, 29. As yet another example, the exhaust system 23 may omit the resonator 28.

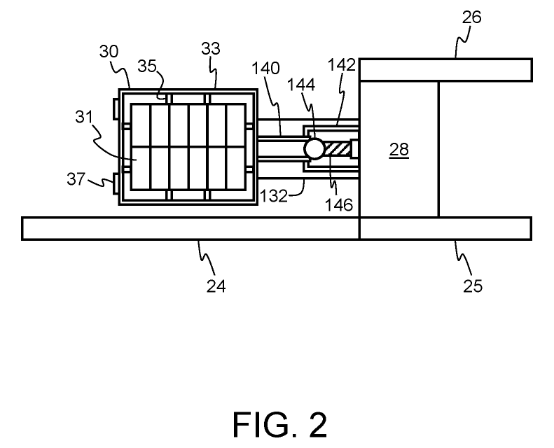

The RESS 30 includes one or more battery modules 31 (FIGS. 2-4) for storing and supplying electrical power for an electric motor of the propulsion system 20, if present, and/or other systems connected to one or more electrical grids or systems onboard the vehicle 10. The electrical system(s) may couple the RESS 30 to one or more accessories of the vehicle 10, such as audio devices, lighting devices, etc. In some examples, the battery modules 31 may include high-capacity lithium-ion batteries or other types of rechargeable batteries such as nickel-metal hydride (NiMH) or solid-state batteries. The battery modules 31 may be charged by operation of the internal combustion engine, with a regenerative braking system, and/or by an external energy supply. In various examples, the RESS 30 may include a sealed housing 33 (FIGS. 2-4) defining an exterior of the RESS 30 and having an internal compartment for storing the battery modules 31, and a support assembly 35 (FIGS. 2-4) within the internal compartment that secure positions of the battery modules 31 within the internal compartment. In some examples, the RESS 30 may include or be coupled with a cooling system configured to maintain desirable temperatures of or within the RESS 30.

With continued reference to FIG. 1, the system includes a fluidic connection between the internal compartment of the RESS 30 and the exhaust system 23. In this example, a device 32 fluidically couples the internal compartment to the resonator 28; however, it should be understood that the device 32 may connect the RESS 30 to other portions of the exhaust system 23 in other examples. The device 32 is configured to selectively allow gases within the internal compartment to enter the exhaust system 23 and thereby be directed to the first and/or second outlets 27, 29 thereof to be released to the ambient environment. In this manner, the system may reduce the likelihood of and/or mitigate the effects of thermal runaway by removing undesirable gases from the internal compartment. Typically, such gases may be combustible and have elevated temperatures well above the normal operating temperature of the battery modules 31. Removal of these gases may therefore reduce temperatures within the housing 33 and thereby reduce a likelihood of thermal runaway therein.

The device 32 may include various components configured to provide the above-noted functionality. In some examples, the device 32 may include one or more valves, burst discs, or other components configured to maintain a fluidic seal between the internal compartment and the exhaust system 23 during normal operation of the vehicle 10 such that exhaust gases do not enter the internal compartment, and to allow passage of the undesirable gases through the device 32 in response to certain predetermined conditions within the internal compartment, such as exceeding one or more thresholds of a gas pressure within the internal compartment. In such examples, the undesirable gases may be released in response to the gas pressure in the internal compartment exceeding a threshold corresponding to a gas pressure indicative of thermal runaway, or a threshold indicative of production of the undesirable gases but prior to initiation of thermal runway. The device 32 may be passive, actively controlled, or a combination thereof.

FIGS. 2-4 illustrate various nonlimiting examples of the device 32. It should be noted that these examples are merely for illustrative purposes and the system of FIG. 1 may have other configurations, including various combinations of the components represented in FIGS. 2-4.

In example of FIG.2, a device 132 includes a passive, one-way check valve. In this example, the one-way check valve includes a valve body that includes a first chamber 140 fluidically coupled to the internal compartment of the housing 33 via an inlet and a second chamber 142 fluidically coupled to the resonator 28 via an outlet. A connection (e.g., seat) between the first and second chambers 140, 142 is releasably sealed with a check ball 144 (or disc). The check ball 144 is biased toward the first chamber 140 with a biasing member 146 (e.g., a spring). With this type of arrangement, if the gas pressure in the internal compartment exceeds the biasing force of the biasing member 146, the check ball 144 will move toward the outlet and thereby unseal the connection between the first and second chambers 140, 142. If the gas pressure within the internal compartment subsequently drops below the biasing force of the biasing member 146, the check ball 144 will move toward the inlet and re-seal the connection. As such, the biasing member 146 may be configured to provide a biasing force corresponding to a predetermined threshold of the gas pressure within the internal compartment.

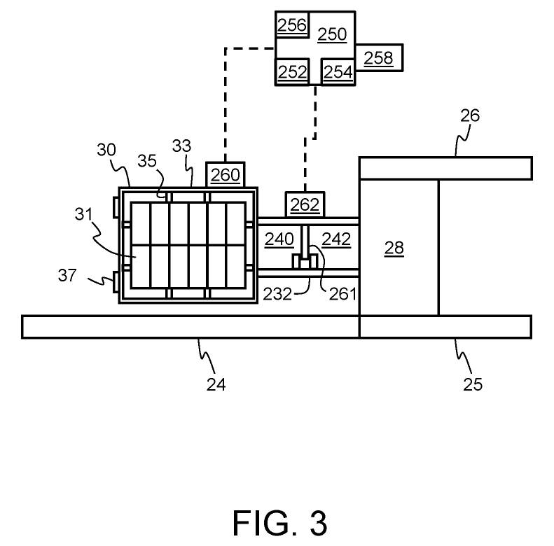

In the example of FIG. 3, a device 232 includes an electronically controlled valve. In this example, the valve includes a valve body that includes a first chamber 240 fluidically coupled to the internal compartment of the housing 33 via an inlet and a second chamber 242 fluidically coupled to the resonator 28 via an outlet. A connection (e.g., seat) between the first and second chambers 240, 242 is releasably sealed with a valve member 261 that may be moved relative to the connection with an actuator 262 to open and close the valve and thereby allow or prevent passage of gases between the first and second chambers 240, 242.

A controller 250 may be provided to manage operation of the device 232, and at least one sensor 260 may be provided to monitor the status of the internal compartment of the RESS 30. In such examples, the controller 250 is operably coupled with the sensor 260 and the actuator 262. The sensor 260 may be configured to sense one or more conditions within the housing 33, such as the gas pressure and/or temperature within the internal compartment.

The controller 250 includes at least one processor 252, a communication bus 254, and a computer readable storage device or media 256. The processor 252 performs the computation and control functions of the controller 250. The processor 252 can be any custom made or commercially available processor, a central processing unit (CPU), a graphics processing unit (GPU), an auxiliary processor among several processors associated with the controller 250, a semiconductor-based microprocessor (in the form of a microchip or chip set), a macroprocessor, any combination thereof, or generally any device for executing instructions. The computer readable storage device or media 256 may include volatile and nonvolatile storage in read-only memory (ROM), random-access memory (RAM), and/or keep-alive memory (KAM). The computer-readable storage device or media 256 may be implemented using any of a number of known memory devices such as PROMs (programmable read-only memory), EPROMs (erasable PROM), EEPROMs (electrically erasable PROM), flash memory, or any other electric, magnetic, optical, or combination memory devices capable of storing data, some of which represent executable instructions. The bus 254 serves to transmit programs, data, status and other information or signals between the various components of the controller 250. The bus 254 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 252, receive and process signals from the sensor 260, perform logic, calculations, methods and/or algorithms, and generate data based on the logic, calculations, methods, and/or algorithms. Although only one controller 250 is shown in FIG. 3, the system can include any number of controllers 250 that communicate over any suitable communication medium or a combination of communication mediums and that cooperate to process the sensor signals, perform logic, calculations, methods, and/or algorithms, and generate data.

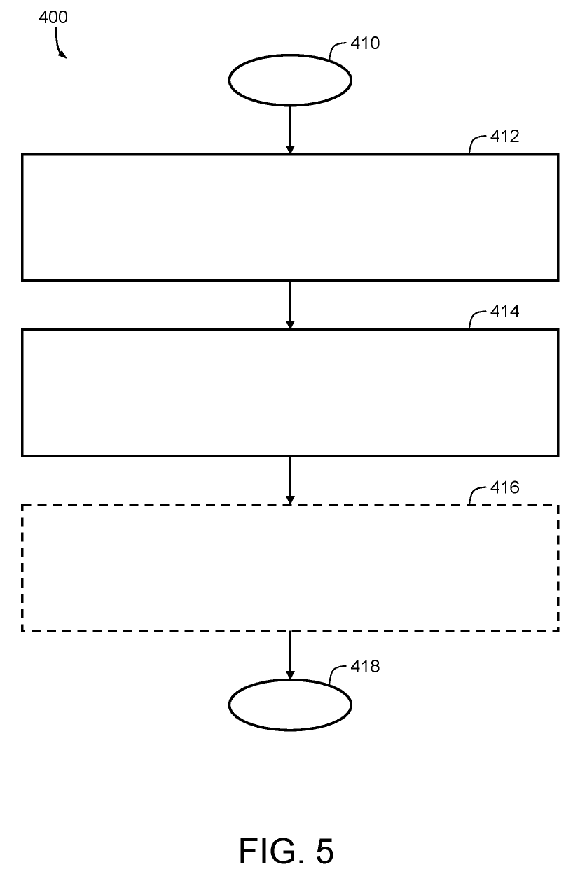

In some examples, a data storage device 258 may be provided to store data for use by the controller 250. The storage device 258 can be any suitable type of storage apparatus, including various different types of direct access storage and/or other memory devices. In one example, the storage device 258 comprises a program product from which a computer readable memory device can receive a program that executes one or more examples of one or more processes of the present disclosure, such as the steps of the process discussed further below in connection with FIG. 5. In another example, the program product may be directly stored in and/or otherwise accessed by the memory device and/or one or more other disks and/or other memory devices.

Referring again to FIG. 3, the controller 250 may continuously or periodically receive signals from the sensor 260 indicative of a condition such as, for example, the gas pressure within the internal compartment of the housing 33. The controller 250 may monitor the signals comparing the indicated current gas pressures to one or more preprogrammed thresholds. If the controller 250 determines that the criteria for one or more of the thresholds are met, the controller 250 may transmit control signals to the actuator 262 to open and/or close the valve by moving the valve member 261 relative to the connection between the first and second chambers 240, 242. In some examples, one or more of the thresholds may correspond to gas pressure associated with the production of the undesirable gas and/or of a thermal runaway state.

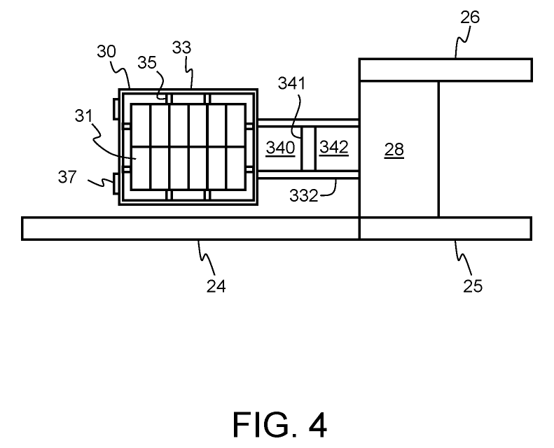

In the example of FIG.4, a device 332 includes a body that includes a first chamber 340 fluidically coupled to the internal compartment of the housing 33 via an inlet and a second chamber 342 fluidically coupled to the resonator 28 via an outlet. A burst disc 341 is disposed between and fluidically separates the first and second chambers 140, 142. The burst disc 341 is a one-time-use membrane that ruptures or fails at a predetermined differential pressure. The pressure at which the burst disc 341 ruptures is referred to herein as the burst pressure. With this type of arrangement, if the gas pressure in the internal compartment exceeds the burst pressure of the burst disc 341, the burst disc 341 will rupture and thereby allow fluidic communication between the first and second chambers 140, 142. As such, the burst disc 341 may be configured to provide a burst pressure corresponding to a predetermined threshold of the gas pressure within the internal compartment.

In some examples, the RESS 30 may include one or more vents 37 (FIGS. 2-4) configured to allow gases generated therein to be released to the ambient atmosphere. In such examples, the vents 37 may be fluidically sealed and configured to only allow the gas to escape therethrough in response to the gas pressure within the internal compartment exceeding a predetermined threshold. For example, the vents 37 may include or be fluidically coupled with a rupture panel or pressure relief valve. If the RESS 30 includes the vents 37, the device 32 may be configured to allow passage of the undesirable gases from the internal compartment to the exhaust system 23 in response to a first threshold for the gas pressure of the internal compartment, and the vents 37 may be configured to allow passage of the undesirable gases from the internal compartment to the ambient environment in response to a second threshold for the gas pressure of the internal compartment, wherein the first threshold is less than the second threshold. That is, upon generation of undesirable gases within the internal compartment, such gases may be release through the device 32 before being released through the vents 37.

This arrangement may provide several advantages relating, for example, to reduced risks of vehicle damage and passenger safety in emergency situations. In particular, the undesirable gases may be combustible and have elevated temperatures. Under certain conditions, exposure of the undesirable gases to the ambient environment may have a potential for auto-ignition of the gases, that is, the gases may ignite without an external source of ignition, such as a flame or spark.

By directing the undesirable gases through the exhaust system 23 prior to release into the ambient environment, the gases may expand and reduce in temperature, thereby significantly reducing the likelihood of auto-ignition upon release. Further, if the undesirable gases mix with the exhaust gases (which are likely low in oxygen content), the undesirable gases may be diluted prior to release, thereby further reducing the likelihood of auto-ignition upon release. Therefore, in some examples, the device 32 may fluidically couple to the exhaust system 23 at a position that is sufficiently upstream of the outlet(s) thereof to modify (e.g., dilute, reduce temperature, etc.) the gases directed therethrough to prevent or reduce a likelihood of auto-ignition upon being released to the ambient environment via the outlet(s). In some examples, the engine of the vehicle 10 may be configured to initiate operation thereof or continue to operate during a thermal runaway event to produce the exhaust gases and thereby dilute the undesirable gases prior to release thereof.

In some examples, the exhaust system 23 is configured to release the undesirable gases through outlet(s) positioned at a rear of the vehicle 10, such as via one or more tailpipes. Such arrangement may provide additional safety advantages for passengers in emergency situations. For example, existing RESSs may be configured to release the undesirable gases through vents positioned below a vehicle. As such, passengers exiting the vehicle may potentially be exposed to the undesirable gases upon exiting the vehicle. In contrast, if the undesirable gases are released to the ambient environment at the rear of the vehicle 10, as with various examples discussed herein, the likelihood of passenger exposure to the undesirable gases may be reduced.

In general, the housings of existing RESSs are typically configured to be fluidically sealed. During a thermal runaway event, reactions occurring within the housing may result in an internal fire. Due to the fluidically sealed construction of existing RESSs, emergency crews may have difficulty extinguishing the internal fire. Therefore, in some examples, the device 32 may function as a water access port for providing water to the internal compartment in emergency situations.

For example, an emergency crew may direct a flow of water from a hose into the outlet(s) of the exhaust system 23 (e.g., a tailpipe). This flow of water may travel through the exhaust system 23, through the device 32, and into the internal compartment of the housing 33. In some examples, the device 32 may already be providing fluidic communication therethrough in response to the generation of the undesirable gases within the internal compartment. In some examples, the device 32 may be configured to allow the water to enter the internal compartment even if the device 32 remains sealed. Various methods may be used to provide such functionality. For example, the pressure of the flow of water from a hose may be in significant excess of a pressure required to force through the device 32. Alternatively, the device 32 may be actively controlled to allow the water to pass therethrough.

In the example of FIG. 2, the device 132 may be modified to include a second check valve oriented in an opposite direction relative to the check valve shown in the figure. The second check valve may be configured with a biasing member that has a biasing force in excess of the normal operating gas pressure within the exhaust system 23, but less than a fluidic pressure provided by the flow of water from a hose. Alternatively, the device 132 may be modified to include a burst disc having a burst pressure configured to remain intact during normal operation and to rupture in response to the flow of water.

In the example of FIG. 3, if the device 232 remains sealed, the electronically controlled valve of the device 232 may be manually opened via user command or automatically opened by the controller 250. In some examples, the valve member 261 may be configured to rupture in response to the fluidic pressure provided by the flow of water from a hose. In some examples, the device 232 may be modified to include a burst disc having a burst pressure configured to remain intact during normal operation and to rupture in response to the flow of water.

In the example of FIG. 4, the burst disc 341 may be configured to rupture in response to the fluidic pressure provided by the flow of water from a hose, which is likely significantly in excess of the burst pressure necessary for release of the undesirable gases generated in the internal compartment.

In some examples, the device 32 may be configured to release gases from within the internal compartment for reasons unrelated to thermal runaway. For example, the device 32 may be configured to release gas from the internal compartment to the exhaust system 23 to allow for pressure equalization between the internal compartment of the housing 33 and the exhaust system 23. Such pressure equalization may be beneficial under various conditions such as upon the vehicle 10 traveling over a pothole or the vehicle 10 rapidly changing altitudes. In such examples, the device 32 may include a one-way valve configured to allow the passage of gas from the internal compartment to the exhaust system 23 in response to gas pressure well below those associated with a potential or active thermal runaway event. In the specific example of FIG. 4, the controller 250 may be configured to allow passage of gases through the valve to equalize pressure between the internal compartment and the exhaust system 23.

With reference now to FIG. 5 and with continued reference to FIGS. 1-4, a flowchart provides a method 400 for preventing and/or mitigating thermal runaway in an RESS or other housing comprising one or more battery modules, for example, as performed by the system of FIG. 1, in accordance with various examples. As can be appreciated in light of the disclosure, the order of operation within the method 400 may not be limited to the sequential execution as illustrated in FIG. 5, but may be performed in one or more varying orders as applicable and in accordance with the present disclosure.

In one example, the method 400 may start at 410. At 412, the method 400 may include directing an exhaust gas produced by a combustion engine of a vehicle through a conduit to an outlet for release into an ambient environment exterior to the vehicle. At 414, the method 400 may include selectively allowing gases within an internal compartment of a sealed housing of an apparatus, such as the housing 33 of the RESS 30, to enter the conduit and thereby be directed to the outlet and released to the ambient environment. In some examples, the gases are released in response to a gas pressure within the internal compartment exceeding a threshold corresponding to a potential or active thermal runaway event. In some examples, the gases are released in response a rapid change in pressure within the internal compartment. For example, the gases may be released to equalize gas pressure between the internal compartment and the conduit. At 416, the method 400 may optionally include supplying water into the outlet, through the conduit, and into the internal compartment of the sealed housing via an emergency water access port fluidically coupling the sealed housing and the conduit. The method 400 may end at 418.

The systems and methods disclosed herein provide various benefits over certain existing systems and methods. For example, allowing for release of gases from the internal compartment of an RESS to an ambient environment through an exhaust system of the vehicle may prevent or mitigate thermal runaway, may promote optimal operation of the RESS (e.g., via pressure equalization), reduce the likelihood of auto-ignition of the gases upon exposure to the ambient environment, reduce the likelihood of damage to the vehicle, promote passenger safety, and/or provide water access to the internal compartment for emergency crews.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for a vehicle, comprising:
a conduit configured to receive exhaust gases from a combustion engine of the vehicle and direct the exhaust gases to an outlet for release into an ambient environment exterior to the vehicle;
a sealed housing with an internal compartment therein and at least one battery module within the internal compartment; and
a device fluidically coupling the internal compartment of the sealed housing and the conduit, wherein the device is configured to selectively allow gases within the internal compartment to enter the conduit and thereby be directed to the outlet thereof and released to the ambient environment.

2. The system of claim 1, wherein the device includes a one-way, passive valve configured to allow passage of the gases from the internal compartment to the conduit in response to a gas pressure within the internal compartment exceeding a predetermined threshold.

3. The system of claim 1, wherein the device includes an electronically controlled valve and a controller having one or more processors, wherein the controller is configured to, by the one or more processors, open the electronically controlled valve to allow passage of the gases from the internal compartment to the conduit in response to a gas pressure within the internal compartment exceeding at least a first threshold.

4. The system of claim 1, wherein the device includes a burst disc configured to rupture and thereby allow passage of the gases from the internal compartment to the conduit in response to a gas pressure within the internal compartment exceeding a predetermined threshold.

5. The system of claim 1, wherein the device fluidically couples to the conduit at a position that is sufficiently upstream of the outlet to dilute the gases directed therethrough and reduce a likelihood of auto-ignition upon being released to the ambient environment.

6. The system of claim 1, wherein the device is configured to function as an emergency water access port wherein water can be directed through the conduit, through the device, and into the internal compartment.

7. The system of claim 1, wherein the device is configured to selectively allow passage of the gases from the internal compartment to the conduit to equalize gas pressure between the internal compartment and the conduit.

8. The system of claim 1, wherein the conduit is configured to direct the gases from the device to a tailpipe at a rear of the vehicle for release into the ambient environment.

9. The system of claim 1, wherein the device is configured to allow passage of the gases from the internal compartment to the conduit in response to a gas pressure within the internal compartment exceeding a predetermined threshold corresponding to a potential or active thermal runaway event.

10. A method for a vehicle, comprising:
directing an exhaust gas produced by a combustion engine of the vehicle through a conduit to an outlet for release into an ambient environment exterior to the vehicle; and
selectively allowing gases within an internal compartment of a sealed housing to enter the conduit and thereby be directed to the outlet thereof and released to the ambient environment, wherein the sealed housing includes at least one battery module within the internal compartment.

11. The method of claim 10, wherein the internal compartment is fluidically coupled to the conduit via a passive, one-way valve, wherein selectively allowing the gases within the internal compartment of the sealed housing to enter the conduit includes configuring the one-way valve to open in response to a gas pressure within the internal compartment exceeding a predetermined threshold.

12. The method of claim 10, wherein the internal compartment is fluidically coupled to the conduit via an electronically controlled valve, wherein selectively allowing the gases within the internal compartment of the sealed housing to enter the conduit includes opening, with a controller having one or more processors, the electronically controlled valve in response to a gas pressure within the internal compartment exceeding at least a first threshold.

13. The method of claim 10, wherein the internal compartment is fluidically coupled to the conduit via a burst disc, wherein selectively allowing the gases within the internal compartment of the sealed housing to enter the conduit includes configuring the burst disc to rupture in response to a gas pressure within the internal compartment exceeding a predetermined threshold.

14. The method of claim 10, further comprising diluting the gases with the exhaust gas within the conduit prior to a mixture thereof being released to the ambient environment.

15. The method of claim 10, further comprising supplying water into the outlet, through the conduit, and into the internal compartment of the sealed housing via an emergency water access port.

16. The method of claim 10, wherein selectively allowing the gases within the internal compartment of the sealed housing to enter the conduit is performed to equalize gas pressure between the internal compartment and the conduit.

17. The method of claim 10, wherein the method comprises allowing passage of the gases from the internal compartment to the conduit in response to a gas pressure within the internal compartment exceeding a predetermined threshold corresponding to a potential or active thermal runaway event.

18. A vehicle, comprising:
a combustion engine;
an exhaust system having a conduit configured to direct exhaust gases from the combustion engine to an outlet for release into an ambient environment exterior to the vehicle;
a rechargeable energy storage system (RESS) having a housing with an internal compartment therein and at least one battery module within the internal compartment; and
a device fluidically connecting the internal compartment of the RESS and the conduit of the exhaust system, wherein the device is configured to selectively allow gases within the internal compartment of the RESS to enter the conduit and thereby be directed to the outlet for release into to the ambient environment in response to a gas pressure within the internal compartment exceeding a predetermined threshold corresponding to a potential or active thermal runaway event.

19. The vehicle of claim 18, wherein the device is configured to function as an emergency water access port wherein water can be directed into the outlet, through the conduit, through the device, and into the internal compartment.

20. The vehicle of claim 18, wherein the device includes a passive, one-way valve, an electronically controller valve, or a burst disc configured to allow passage of the gases from the internal compartment to the conduit in response to the gas pressure within the internal compartment exceeding the predetermined threshold.
